(19) United States
(12) Patent Application Publication
(10) Pub. No.: US 2024/0246175 A1
(43) Pub. Date: Jul. 25, 2024

(54) METHOD OF MANUFACTURING MEMBER

(71) Applicant: FUTABA INDUSTRIAL CO., LTD., Okazaki-shi (JP)

(72) Inventors: Yuji Nakada, Okazaki-shi (JP); Koichiro Yamamoto, Okazaki-shi (JP)

(21) Appl. No.: 18/414,742

(22) Filed: Jan. 17, 2024

(30) Foreign Application Priority Data
Jan. 25, 2023 (JP) 2023-009375

(51) Int. Cl. B23K 26/21; B23K 26/70

(52) U.S. Cl. CPC B23K 26/21; B23K 26/703

(57) ABSTRACT

A method of manufacturing a member includes forming a welded member by joining a first portion of a plate-shaped first plate material and a second portion of a plate-shaped second plate material by laser welding. The method also includes cooling a portion situated near the first portion of the first plate material and a portion situated near the second portion of the second plate material when performing the laser welding.

### CROSS-REFERENCE TO RELATED APPLICATIONS

This application claims the benefit of Japanese Patent Application No. 2023-009375 filed on Jan. 25, 2023 with the Japan Patent Office, the entire disclosure of which is incorporated herein by reference.

### BACKGROUND

The present disclosure relates to a method of manufacturing a component.

As disclosed in Japanese Patent No. 6495987, laser wobble welding, which joins two plate materials together without using a filler material by irradiating a laser beam along a helical path or a zigzag path, is known.

### SUMMARY

A thermally affected portion, formed in the vicinity of a welded portion formed by the laser wobble welding, has reduced hardness, which consequently decreases the tensile strength of the welded portion. There is therefore a risk of an occurrence of a crack when molding a member obtained by joining plate materials together by the laser wobble welding.

In one aspect of the present disclosure, it is desirable to reduce a risk of causing a crack when molding a member obtained by welding.

One aspect of the present disclosure is a method of manufacturing a member. The method includes forming a welded member by joining a first portion of a plate-shaped first plate material and a second portion of a plate-shaped second plate material by laser welding; and cooling a portion situated near the first portion of the first plate material and a portion situated near the second portion of the second plate material when performing the laser welding.

According to the aforementioned configuration, a decrease in the tensile strength of the welded portion formed on the welded member by the laser welding can be inhibited. Accordingly, an occurrence of a crack can be reduced when the welded member is molded.

In one aspect of the present disclosure, each of the portion situated near the first portion of the first plate material and the portion situated near the second portion of the second plate material may be cooled by disposing a metallic cooling member when the laser welding is performed.

In one aspect of the present disclosure, each of the portion situated near the first portion of the first plate material and the portion situated near the second portion of the second plate material may be cooled by disposing a cooling member having a flow path for a cooling medium when the laser welding is performed.

According to the aforementioned configuration, the first plate material and the second plate material can be favorably cooled when the laser welding is performed.

In one aspect of the present disclosure, the laser welding may be laser wobble welding or laser weaving welding.

According to the aforementioned configuration, expansion of the thermally affected portion and/or a decrease in the hardness of the thermally affected portion can be inhibited. Consequently, an occurrence of a crack can be reduced when the welded member is molded.

In one aspect of the present disclosure, the first portion may be an end surface of the first plate material, and the second portion may be an end surface of the second plate material. Butt welding between the first portion and the second portion may be performed by the laser welding.

According to the aforementioned configuration, an occurrence of a crack can be reduced when a welded member formed by the butt welding of the first plate material and the second plate material is molded.

In one aspect of the present disclosure, the welded member may include a fragile portion which is vulnerable. The method of manufacturing a member may further include molding the welded member by applying a pressure on the welded member while pressing the fragile portion with an elastic member.

According to the aforementioned configuration, elongation of the fragile portion can be inhibited when the welded member is molded.

Consequently, an occurrence of a crack can be reduced when the welded member is molded.

In one aspect of the present disclosure, the first plate material and the second plate material have a thickness less than or equal to 1 mm.

According to the aforementioned configuration, an occurrence of a crack can be favorably reduced when the welded member is molded.

In one aspect of the present disclosure, the first plate material and the second plate material may be made of stainless steel.

According to the aforementioned configuration, an occurrence of a crack can be favorably reduced when the welded member is molded.

In one aspect of the present disclosure, the welded member may be mounted to a vehicle.

According to the aforementioned configuration, an occurrence of a crack can be reduced when the welded member that is to be mounted to a vehicle is molded.

### BRIEF DESCRIPTION OF THE DRAWINGS

An example embodiment of the present disclosure will be described hereinafter with reference to the accompanying drawings, in which:

FIG. 1 is an explanatory diagram viewing a first plate material and a second plate material to be welded by laser wobble welding from above;

FIG. 2 is an explanatory diagram viewing the first plate material and the second plate material to be welded by the laser wobble welding from a lateral side;

FIG. 3 is a diagram explaining press molding of a welded member;

FIG. 4 is a diagram explaining hydraulic molding of the welded member; and

FIG. 5 is a perspective view of a molded member.

### DETAILED DESCRIPTION OF EXEMPLARY EMBODIMENTS

The present disclosure may be implemented in various forms, as long as they belong to the technical scope of the present disclosure, without being limited to the embodiments described below.

### 1. Outline

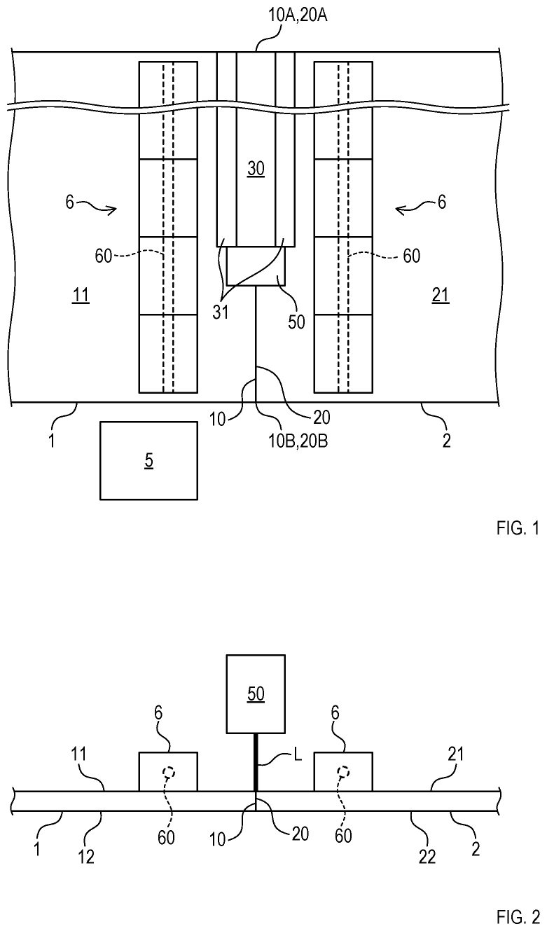

The manufacturing method of the present embodiment includes a welding process and a molding process and produces a molded member 4 from a plate-shaped first plate material and a plate-shaped second plate material (hereinafter, also simply referred to as the plate materials 1, 2) (see FIG. 1 to FIG. 5).

As an example, the plate materials 1, 2 are made of stainless steel and have a planarly spreading rectangular shape having a thickness of 0.6 mm. Nevertheless, the plate materials 1, 2 do not have to be limited to have such features. The plate materials 1, 2 may be made of a steel material other than stainless steel or may be made of a metal other than a steel material. The shape of the plate materials 1, 2 may be appropriately determined. The plate materials 1, 2 may have a thickness less than or equal to 1 mm or may have a thickness exceeding 1 mm without being limited to 0.6 mm.

The molded member 4 may be a large member used for a vehicle for example. More specifically, the molded member 4 may be a member on or in which a battery is placed in an electric vehicle, for example. It is needless to say that the application of the molded member 4 is not limited to these examples. The manufacturing method of the present embodiment may produce molded members 4 included in a different member mounted to a vehicle, or a molded member 4 used in various applications other than components mounted to vehicles.

### 2. Welding Process

In the welding process, a welded member 3 is formed by butt welding of the plate materials 1, 2 by the laser welding (see FIG. 1 and FIG. 2). In the welding process, the laser wobble welding is performed as an example; alternatively, laser weaving welding may be performed, or laser welding other than the laser wobble welding or the laser weaving welding may be performed.

### [(1) Arrangement of Plate Material]

In the welding process, the butt welding between an end surface forming one side of the first plate material 1 (hereinafter referred to as the first end surface 10) and an end surface forming one side of the second plate material 2 (hereinafter referred to as the second end surface 20) is performed by the laser wobble welding (see FIG. 1 and FIG. 2). This produces the welded member 3 having a plate-shape of a planarly spreading rectangular. For example, the welded member 3 may be in a size larger than the sizes of stainless steel plates available from manufacturers. Nevertheless, it is needless to say that the size of the welded member 3 may be appropriately determined.

More specifically, the plate materials 1, 2 are horizontally placed on a workbench with the first end surface 10 and the second end surface 20 (hereinafter also simply referred to as the end surfaces 10, 20) contact with each other. The plate materials 1, 2 may be placed on the workbench with a slight clearance (for example, about 1 mm) between the first end surface 10 and the second end surface 20. A top surface of the first plate material 1 placed on the workbench is a first surface 11, and likewise, a top surface of the second plate material 2 placed on the workbench is a first surface 21.

### [(2) Arrangement of Cooling Member]

A cooling member 6 is placed on each of the first surfaces 11, 21 of the plate materials 1, 2 along the end surfaces 10, 20 (see FIG. 1 and FIG. 2). The cooling members 6 are placed on the plate materials 1, 2 from respective first end 10A, 20A of the end surfaces 10, 20 towards respective second end 10B, 20B of the end surfaces 10, 20 and are placed apart from the end surfaces 10, 20. The cooling members 6 placed on the plate materials 1, 2 are situated near the end surfaces 10, 20. In other words, these cooling members 6 may be situated close to a welded portion 30, which will be explained later, formed near the end surfaces 10, 20; and more specifically, these cooling members 6 may be situated close to thermally affected portions 31, which will be explained later, formed near the end surfaces 10, 20. The cooling members 6 may be placed about 20 mm apart from the end surfaces 10, 20, for example. The distance between the cooling members 6 and the end surfaces 10, 20 may be less than 20 mm if the cooling members 6 do not contact a shielding gas nozzle. As long as a cooling effect can be obtained, the distance between the cooling members 6 and the end surfaces 10, 20 may be greater than 20 mm. Accordingly, there is a space between the cooling member 6 placed on the first plate material 1 and the cooling member 6 placed on the second plate material 2, and the end surfaces 10, 20 are situated in this space.

Each of the cooling members 6 placed on the plate materials 1, 2 may include a plurality of copper plates arranged in line along each of the end surfaces 10, 20, or may include a single elongated copper plate extending along each of the end surfaces 10, 20, for example. It is needless to say that the cooling member 6 may include a metal other than copper.

The cooling member 6 may be configured as a flow path 60 for a cooling medium such as water, for example, and may be configured to perform cooling by causing the cooling medium to flow through the flow path 60. More specifically, the flow path 60 for the cooling medium may be formed inside the plurality of copper plates included in the cooling member 6, and cooling may be performed by causing the cooling medium to flow through this flow path 60, for example.

### [(3) Laser Wobble Welding]

While cooling is performed by the cooling members 6, the butt welding between the first end surface 10 of the first plate material 1 and the second end surface 20 of the second plate material 2 is performed by the laser wobble welding (see FIG. 1 and FIG. 2). More specifically, a laser beam L is irradiated from a laser head 50 of a laser device 5 on an area in the vicinity of the first end surface 10 on the first surface 11 of the first plate material 1 and an area in the vicinity of the second end surface 20 on the first surface 21 of the second plate material 2. The laser device 5 performs the butt welding of the end surfaces 10, 20 from the first ends 10A, 20A to the second ends 10B, 20B by moving the laser head 50. Meanwhile, the laser device 5 adjusts the direction of irradiation of the laser beam L by using an adjustment mechanism (for example, a galvanometer mirror) disposed inside the laser head 50 such that the irradiation position moves along a helically formed path, for example. It is needless to say that the laser beam L may be irradiated along a zigzag path, for example. Alternatively, rather than changing the direction of irradiation of the laser beam L, the irradiation position of the laser beam L may be moved by changing the orientation of the plate materials 1, 2 by moving the workbench.

After the butt welding between the first surface 11 of the first plate material 1 and the first surface 21 of the second plate material 2 is performed by the laser wobble welding, the plate materials 1, 2 may be turned upside down and placed on the workbench with second surfaces 12, 22 facing upward. The butt welding may also be performed in this orientation by performing the laser wobble welding on an area in the vicinity of the first end surface 10 on the second surface 12 of the first plate material 1 and on an area in the vicinity of the second end surface 20 on the second surface 22 of the second plate material 2 in a manner similar to the first surfaces 11, 21. It is needless to say that the laser wobble welding may be performed only on the first surfaces 11, 21 of the plate materials 1, 2.

On the plate materials 1, 2, the welded portion 30 is formed in the vicinity of the end surfaces 10, 20 by solidification of a material melted by the irradiation of the laser beam L. The welded portion 30 extends from a first end to a second end of the welded member 3. The thermally affected portions 31 are formed on both elongated sides of the welded portion 30 of the welded member 3.

### [3. Molding Process]

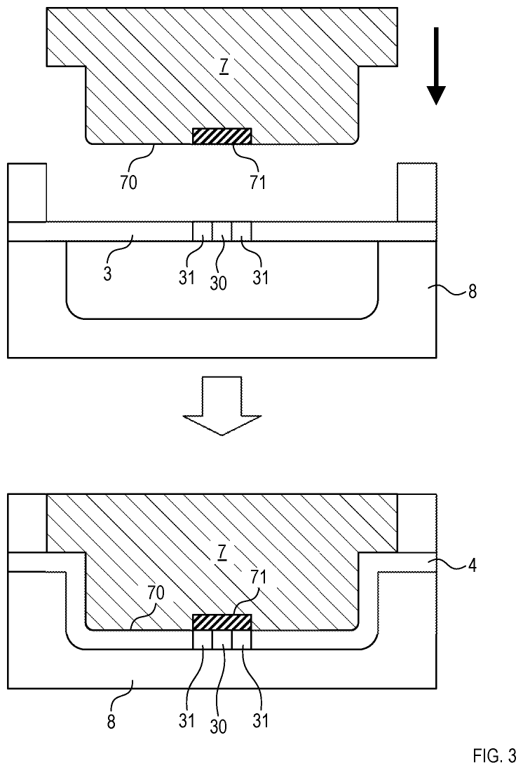

In the molding process, molding of the welded member 3 is performed with a fragile portion, which is a vulnerable part of the welded member 3, being pressed with an elastic member. This produces the molded member 4 (see FIG. 3). The fragile portion may be the welded portion 30 and the thermally affected portions 31 formed by the laser wobble welding, for example.

In the molding process, press molding using a punching 7 and a female mold 8 is performed, for example (see FIG. 3). More specifically, the welded member 3 is first placed on the female mold 8; a pressing surface 70 of the punching 7 is then placed on the welded member 3; and the welded member 3 is then pressed downward towards the female mold 8 by the punching 7.

An elastic member 71 (for example, rubber) is disposed on the pressing surface 70 of the punching 7. The elastic member 71 extends on the pressing surface 70 from a position corresponding to first ends of the welded portion 30 and the thermally affected portions 31 to a position corresponding to second ends of the welded portion 30 and the thermally affected portions 31. When the punching 7 presses the welded member 3, the elastic member 71 contacts and presses the entirety of the welded portion 30 and the thermally affected portions 31 of the welded member 3. When the punching 7 presses the welded member 3, the elastic member 71 may press only the entirety of the welded portion 30, or only the entirety of the thermally affected portions 31, or only a specified portion of the welded portion 30 and/or the thermally affected portions 31 where a crack may easily occur. In addition to or in place of the elastic member 71 of the punching 7, the fragile portion of the welded member 3 may likewise be pressed by an elastic member disposed on the female mold 8.

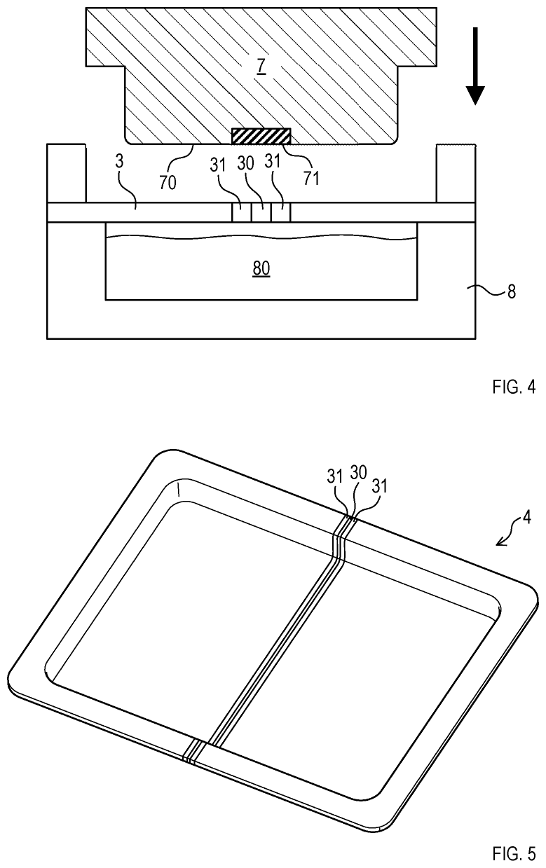

Other than by the press molding, the welded member 3 may be molded by hydraulic molding, for example (see FIG. 4). More specifically, the welded member 3 may be placed on the female mold 8 which is filled with liquid 80, such as water, and pressed by the punching 7, configured similarly to the punching 7 used in the press molding, from above. The fragile portion of the welded member 3 may likewise be pressed by the elastic member 71. This configuration also yields the same effect as seen in the press molding.

In place of the elastic member 71 disposed on the punching 7, a plate-like elastic member adhered onto the fragile portion of the welded member 3 may be used to press the fragile portion. In other words, the welded member 3 may be placed on the female mold 8 with the plate-like elastic member adhered onto the welded portion 30 and/or the thermally affected portions 31. At this time, the surface of the welded member 3 where the elastic member is adhered to may face upward (in other words, face the punching 7). In a case of performing the press molding, the surface of the welded member 3 where the elastic member is adhered to may face downward (in other words, face the female mold 8). The welded member 3 may then be molded by being pressed by the punching without the elastic member 71 while the fragile portion is pressed by the elastic member.

### [4. Effects]

(1) There is a case where a large plate material is formed by joining thin plate materials made of stainless steel and having a thickness of about 0.6 mm by the laser welding, and then molding thus formed large plate material. In such a case, welding between such thin plate materials may be difficult or impossible due to thermal strain and/or burn-through when the output power of the laser beam is high at the time of performing the laser welding (for example, about 2 to 7 kW).

The plate materials made of stainless steel have a characteristic that materials thereof flow along its surface rather than moving in the direction of load application when a load is applied on the surface. At the welded portion produced by the laser welding, its hardness is increased. At the same time, the hardness is decreasing at the thermally affected portion in the vicinity of the welded portion. Accordingly, in the vicinity of the welded portion and the thermally affected portion, elongation of the material is uneven. Consequently, the tensile strength of the welded portion and the thermally affected portion is less than the tensile strength of other portions that are not affected by the laser welding. Accordingly, even if the aforementioned thin plate materials can be welded together, cracks may occur in their welded portions and/or thermally affected portions when molding the large plate material obtained by the welding.

Meanwhile, in the aforementioned embodiment, when the end surfaces 10, 20 of the plate materials 1, 2 are joined together by the laser wobble welding, the cooling members 6 cool the vicinity of the end surfaces 10, 20 of the plate materials 1, 2. This promptly removes heat input by the laser wobble welding. Consequently, burn-throughs and/or strains of the plate materials 1, 2 can be inhibited, and the laser wobble welding can be favorably performed.

Prompt removal of the heat input by the cooling member 6 can facilitate structural refinement of the welded portion 30 and the thermally affected portions 31, and inhibit the thermally affected portions 31 from expanding and/or inhibit the hardness of the thermally affected portions 31 from decreasing. Consequently, a decrease in the tensile strength of the thermally affected portions 31 and the welded portion 30 of the welded member 3 can be inhibited, which facilitates the tensile strength of the thermally affected portions 31 and the welded portion 30 to be the same level as the tensile strength of other portions of the welded member 3. Accordingly, occurrences of a crack on the welded portion 30 and the thermally affected portions 31 of the welded member 3 can be reduced in the molding process, and thus the welded member 3 can be favorably molded.

(2) In the welding process, the butt welding between the first end surface 10 of the first plate material 1 and the second end surface 20 of the second plate material 2 by the laser wobble welding. This can facilitate structural refinement of the welded portion 30 and the thermally affected portions 31, and inhibit the thermally affected portions 31 from expanding and/or inhibit the hardness of the thermally affected portion 31 from decreasing. Accordingly, a decrease in the tensile strength of the thermally affected portions 31 and the welded portion 30 of the welded member 3 can be inhibited, which can consequently reduce occurrences of a crack on the welded member 3 in the molding process.

(3) In the molding process, the welded member 3 is molded with the welded portion 30 and the thermally affected portions 31 of the welded member 3 being pressed by the elastic member 71. This inhibits the materials from flowing in a direction along a surface of the welded member 3 in the welded portion 30 and the thermally affected portions 31. Consequently, elongation of the welded portion 30 and the thermally affected portions 31 can be inhibited, which can therefore reduce occurrences of a crack on the welded portion 30 and the thermally affected portions 31 when the welded member 3 is molded.

### [5. Other Embodiments]

(1) In the molding process of the aforementioned embodiment, fragile portions of the welded member 3 other than the welded portion 30 and the thermally affected portions 31 may be pressed by the elastic member in addition to or in place of pressing the welded portion 30 and the thermally affected portions 31.

(2) In the welding process of the aforementioned embodiment, butt welding is performed. Alternatively, fillet welding or lap welding, for example, may be performed in place of the butt welding. More specifically, the first plate material 1 and the second plate material 2 may be placed such that the first surface 11 of the first plate material 1 contacts the second surface 22 of the second plate material 2. The fillet welding may then be performed between the second end surface 20 of the second plate material 2 and the first surface 11 of the first plate material 1. Alternatively, the lap welding may then be performed to join the first surface 11 of the first plate material 1 with the second surface 22 of the second plate material 2 along the second end surface 20 of the second plate material 2. At this time, likewise the aforementioned embodiment, the cooling members 6 are disposed from the first end to the second end of the second end surface 20 along the second end surface 20, and the fillet welding or the lap welding may be performed while an area on the first plate material 1 in the vicinity of the second end surface 20 and an area on the second plate material 2 in the vicinity of the second end surface 20 are cooled.

(3) Two or more functions of one element in the aforementioned embodiments may be achieved by two or more elements, or one function of one element may be achieved by two or more elements. In addition, two or more functions of two or more elements may be achieved by one element, or one function of two or more elements may be achieved by one element. A part of the configurations in the aforementioned embodiments may be omitted. Furthermore, at least a part of the configurations of the aforementioned embodiments may be added to or replaced with another part of the configurations of the aforementioned embodiments.

### [6. Technical Ideas Disclosed in the Specification]

### [Item 1]

Item 1 is a method of manufacturing a member. The method includes forming a welded member by joining a first portion of a plate-shaped first material and a second portion of a plate-shaped second plate material by laser welding, and cooling a portion situated near the first portion of the first plate material and a portion situated near the second portion of the second plate material when performing the laser welding.

### [Item 2]

Item 2 is the method described in Item 1, in which the laser welding is laser wobble welding or laser weaving welding.

### [Item 3]

Item 3 is the method described in Item 1 or Item 2, in which the first portion is an end surface of the first plate material, and the second portion is an end surface of the second plate material. Butt welding between the first portion and the second portion is performed by the laser welding.

### [Item 4]

Item 4 is the method described in any one of Item 1 to Item 3, in which the welded member includes a fragile portion which is vulnerable. The method further includes molding the welded member by applying a pressure on the welded member while pressing the fragile portion with an elastic member.

### [7. Correspondence of Languages]

The first end surface 10 corresponds to an example of the first portion. The second end surface 20 corresponds to an example of the second portion.

What is claimed is:

1. A method of manufacturing a member, the method comprising:
forming a welded member by joining a first portion of a plate-shaped first plate material and a second portion of a plate-shaped second plate material by laser welding; and
cooling a portion situated near the first portion of the first plate material and a portion situated near the second portion of the second plate material when performing the laser welding.

2. The method according to claim 1,
wherein each of the portion situated near the first portion of the first plate material and the portion situated near the second portion of the second plate material is cooled by disposing a metallic cooling member when the laser welding is performed.

3. The method according to claim 1,
wherein each of the portion situated near the first portion of the first plate material and the portion situated near the second portion of the second plate material is cooled by disposing a cooling member having a flow path for a cooling medium when the laser welding is performed.

4. The method according to claim 1,
wherein the laser welding is laser wobble welding or laser weaving welding.

5. The method according to claim 1,
wherein the first portion is an end surface of the first plate material,
wherein the second portion is an end surface of the second plate material, and
wherein butt welding between the first portion and the second portion is performed by the laser welding.

6. The method according to claim 1,
wherein the welded member includes a fragile portion which is vulnerable, and
wherein the method further comprises molding the welded member by applying a pressure on the welded member while pressing the fragile portion with an elastic member.

7. The method according to claim 1,
wherein the first plate material and the second plate material have a thickness less than or equal to 1 mm.

8. The method according to claim 1,
wherein the first plate material and the second plate material are made of stainless steel.

9. The method according to claim 1,
wherein the welded member is mounted to a vehicle.
